(19) United States
(12) Patent Application Publication
(10) Pub. No.: US 2014/0160776 A1
(43) Pub. Date: Jun. 12, 2014

(54) VEHICLE TRACK LIGHTED ACCESSORY

(71) Applicant: NISSAN NORTH AMERICA, INC., Franklin, TN (US)

(72) Inventors: Bhargav SURA, Sterling Heights, MI (US); Randall JOHNSON, White Lake, MI (US)

(73) Assignee: Nissan North America, Inc., Franklin, TN (US)

(21) Appl. No.: 13/708,088

(22) Filed: Dec. 7, 2012

(51) Int. Cl. B60Q 1/00

(52) U.S. Cl. CPC B60Q 1/00
USPC 362/485

(57) ABSTRACT

A vehicle track lighted accessory includes a main body, a track attachment structure and a lamp. The track attachment structure is movably connected to the main body between a track attached orientation and a track released orientation. The lamp is at least partially disposed within the main body.

### BACKGROUND

1. Field of the Invention

The present invention generally relates to a vehicle track lighted accessory. More specifically, the present invention relates to an accessory that includes lighting, the accessory being installable to and removable from an accessory track within a vehicle cargo area.

2. Background Information

Vehicle cargo areas, such as pickup truck cargo beds, are typically not provided with lighting. Thus it is difficult to see items on the floors of such cargo areas at night.

### SUMMARY

One object is to provide a vehicle cargo area with a lighting accessory.

Another object is to provide the vehicle cargo area with a flexible lighting arrangement where lamps can be positioned at a variety of locations within the cargo area.

In view of the state of the known technology, one aspect of the present disclosure is to provide a cargo area of a vehicle with a vehicle track lighted accessory. The vehicle track lighted accessory includes a main body, a track attachment structure and a lamp. The track attachment structure is movably connected to the main body between a track attached orientation and a track released orientation. The lamp is at least partially disposed within the main body.

### BRIEF DESCRIPTION OF THE DRAWINGS

Referring now to the attached drawings which form a part of this original disclosure:

FIG. 1 is a rear view of a vehicle cargo area that includes a wall structure facing the cargo area, the cargo area having a plurality of accessory mounting tracks fixed to the wall structure, with a lighted accessory installed to one of the accessory mounting tracks providing light to the cargo area in accordance with various embodiments;

FIG. 2 is a rear elevational view of the wall structure and the cargo area showing one of the accessory mounting tracks and the lighted accessory in accordance with a first embodiment;

FIG. 3 is a perspective view of one of the accessory mounting tracks shown removed from the cargo area, showing the lighted accessory attached to the accessory mounting track in accordance with the first embodiment;

FIG. 4 is a cross-sectional view of the lighted accessory removed from the accessory mounting track, taken along the line 4-4 in FIG. 3, showing details of lighting components of the lighted accessory in accordance with the first embodiment;

FIG. 5 is another cross-sectional view of the lighted accessory taken along the line 5-5 in FIG. 3, showing further details of lighting components, with the lighted accessory clamped to the accessory mounting track in accordance with the first embodiment;

FIG. 6 is another cross-sectional view of the lighted accessory similar to FIG. 5, showing further details of lighting components, with the lighted accessory unclamped from the accessory mounting track and rotated 90 degrees for removal from the accessory mounting track in accordance with the first embodiment;

FIG. 7 is a cross-sectional view of a lighted accessory similar to FIG. 3, showing details of lighting components of the lighted accessory in accordance with a second embodiment;

FIG. 8 is a perspective view of one of the accessory mounting tracks shown removed from the cargo area, showing a lighted accessory attached to the accessory mounting track in accordance with a third embodiment;

FIG. 9 is a cross-sectional view of the lighted accessory removed from the accessory mounting track, taken along the line 9-9 in FIG. 8, showing details of lighting components of the lighted accessory in accordance with the third embodiment;

FIG. 10 is a perspective view of one of the accessory mounting tracks shown removed from the cargo area, showing a lighted accessory attached to the accessory mounting track in accordance with a fourth embodiment;

FIG. 11 is a cross-sectional view of a lighted accessory removed from the accessory mounting track, showing details of lighting components of the lighted accessory including a retractable 110 volt plug electrically coupled to a rechargeable battery in accordance with a fifth embodiment;

FIG. 12 is a side view of the lighted accessory depicted in FIG. 11 shown installed to a first accessory mounting track, with a second accessory track having a 110 volt outlet, with the lighted accessory in an unplugged state relative to the 110 volt outlet in accordance with the fifth embodiment;

FIG. 13 is another side view of the lighted accessory similar to the view in FIG. 12, with the lighted accessory in a plugged-in state relative to the 110 volt outlet in accordance with the fifth embodiment;

FIG. 14 is a perspective view of one of the accessory mounting tracks shown removed from the cargo area, showing a lighted accessory attached to the accessory mounting track in accordance with a sixth embodiment; and

FIG. 15 is a cross-sectional view of the lighted accessory removed from the accessory mounting track, taken along the line 15-15 in FIG. 14, showing details of lighting components of the lighted accessory in accordance with the sixth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

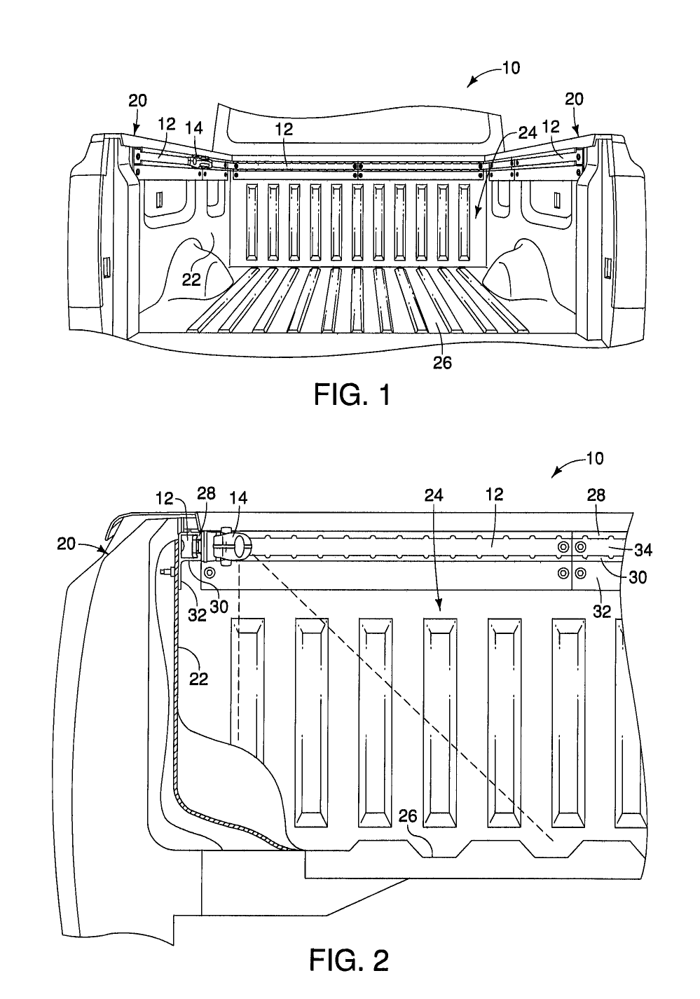

Referring initially to FIG. 1, a vehicle 10 that includes an accessory attachment track 12 and at least one lighted accessory 14 is illustrated in accordance with a first embodiment.

As shown in FIGS. 1 and 2, the vehicle 10 includes a wall structure 20 having an inboard facing surface 22 facing a cargo area 24. The cargo area 24 includes a floor 26, with the inboard facing surface 22 extending upward from the floor 26 and being approximately perpendicular to the floor 26. In the depicted embodiments, the vehicle 10 is a pickup truck. However, it should be understood from the drawings and the description herein that the vehicle 10 can be any vehicle that includes a cargo area, such as a semi-trailer truck, a cargo van, or other similar vehicle. Further, in the depicted embodiment, the cargo area 24 has an open upper end. The cargo area 24 can alternatively be an enclosed space with a roof structures and wall structures that extend from the floor 26 to the roof structure.

In the depicted embodiment, there are several of the accessory attachment tracks 12. Each of the accessory attachment tracks 12 is identical. Therefore, description of one accessory attachment track 12 applies to all.

The accessory attachment track 12 is fastened or otherwise rigidly attached to the inboard facing surface 22. The accessory attachment track 12 is an elongated member that includes an upper portion 28, a lower portion 30 and flange portion 32, with a slot 34 being defined between the upper portion 28 and the lower portion 30. Further description of the accessory attachment track 12 can be found in, for example, U.S. Pat. No. 7,175,377, issued Feb. 13, 2007 (assigned to Nissan Technical Center North America) and U.S. Pat. No. 7,874,774, issued Jan. 25, 2011 (assigned to Nissan North America). The entire disclosures of both U.S. Pat. No. 7,175,377, and U.S. Pat. No. 7,874,774, are incorporated herein by reference in their entirety.

The flange portion 32 of the accessory attachment track 12 is fixed to the wall structure 20 at a location spaced apart from and above the floor 26. In the depicted embodiment, the accessory attachment track 12 is fastened to the inboard facing surface 22 proximate an upper edge of the wall structure 20. As is indicated in both FIGS. 1 and 2, several of the accessory attachment tracks 12 can be installed to the cargo area 24 of the vehicle 10. For example, in the depicted embodiment, one of the attachment tracks 12 is installed to a front wall of the cargo area 24 and separate ones of the attachment tracks 12 are installed to each of the side wall structures 20 on either side of the cargo area 24.

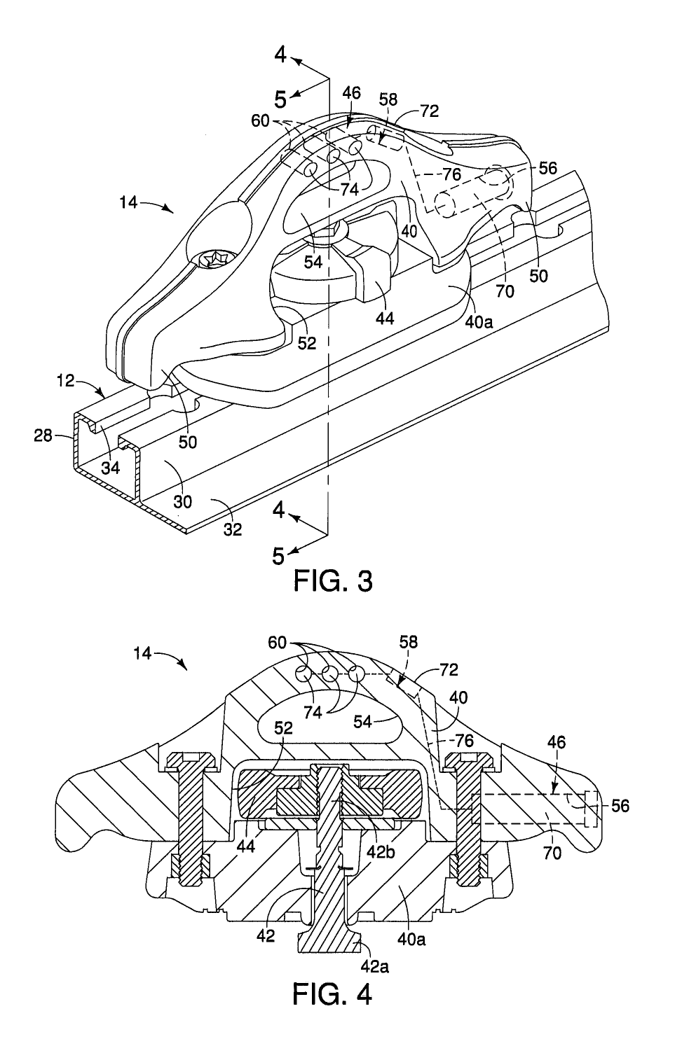

A first embodiment of the lighted accessory 14 is now described with specific reference to FIGS. 3, 4 and 5. The lighted accessory 14 is a device that can be installed and removed from the accessory attachment track 12. The lighted accessory 14 can also be moved along the accessory attachment track 12 and repositioned at any of a plurality of positions along the length of the accessory attachment track 12. Specifically, portions of the lighted accessory 14 are configured to clamp to the accessory attachment track 12 and can later be released from the accessory attachment track 12, as is described in U.S. Pat. No. 7,175,377 and U.S. Pat. No. 7,874,774, and briefly described below.

In the depicted embodiment, the lighted accessory 14 is a tie down cleat that can be used to secure rope or the like to tie down cargo loaded in the cargo area. However, it should be understood from the drawings and the description herein, that the lighted accessory 14 can be any of a variety of accessories for use in the cargo area 24 that removably attach to the accessory attachment track 12, and also include lighting features in order to provide illumination to the cargo area 24. More specifically, the lighted accessory 14 includes a lighting arrangement such that the cargo area 24 is illuminated by the lighted accessory 14, and the lighted accessory 14 has additional functionality, such as tie-down features described below.

As shown in FIGS. 3, 4 and 5, the lighted accessory 14 includes a main body 40, a retainer 42, a rotatable handle 44 and lighting components 46. The main body 40 includes an upper section that includes cleat tie-down ends 50 (prongs), a recess 52 and a handle 54. The cleat tie-down ends 50 and the handle 54 of the main body 40 are shaped to receive rope or other similar material that can be used to secure cargo placed in the cargo area 24. As shown in FIG. 4, the main body 40 also includes a battery receiving recess 56, a switch recess 58 and lamp receiving apertures 60. The main body 40 also includes a lower section 40a that is shaped to contact and clamp against the accessory attachment track 12, as is described further below. The main body 40 and the lower section 40a of the main body 40 are attached to one another by, for example, removable fasteners.

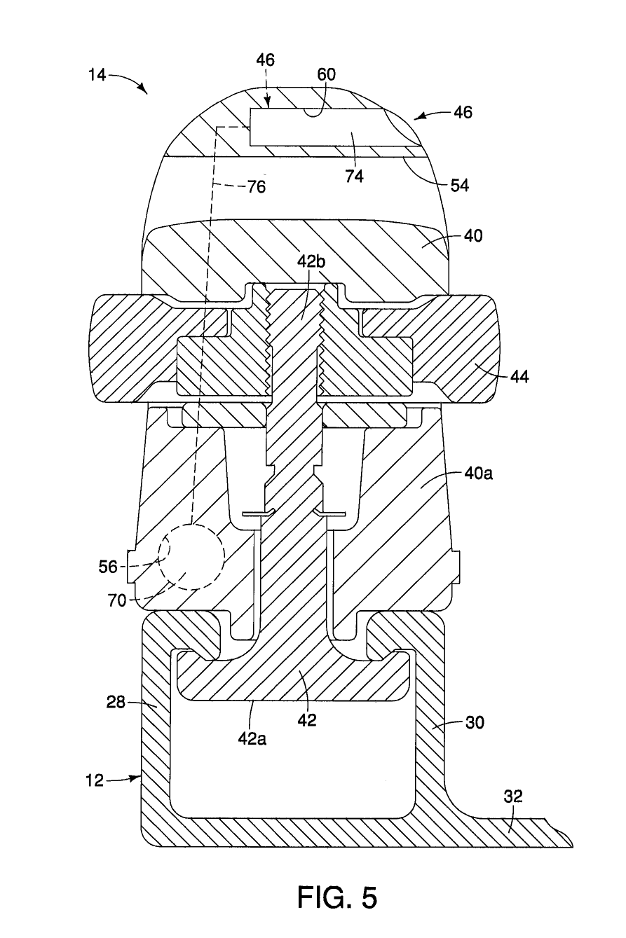

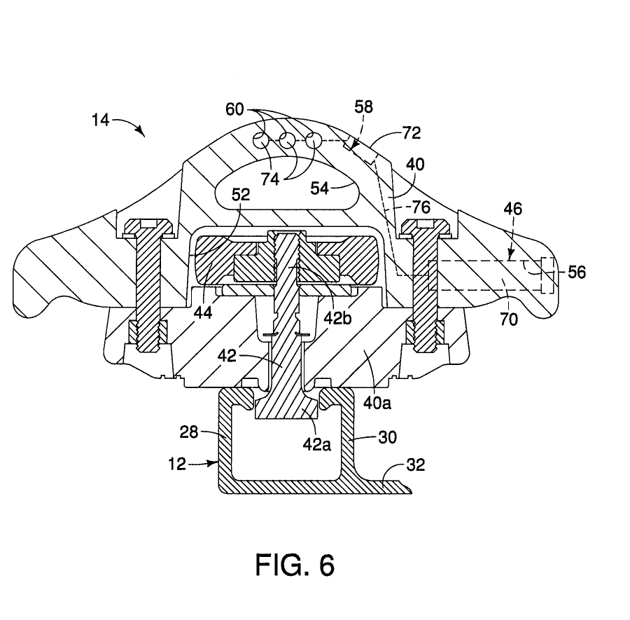

The main body 40, the retainer 42 and the rotatable handle 44 together define a track attachment structure that movably connects to the lighted accessory 14 between a track attached orientation (FIG. 5) and a track released orientation (FIG. 6), as described in further detail below.

The retainer 42 includes a first end 42a and a second end 42b. The retainer 42 is installed within an aperture formed in the main body 40 such that the second end 42b extends to the recess 52. The rotatable handle 44 is disposed within the recess 52 of the main body 40 of the lighted accessory 14 and includes a central threaded aperture that receives the second end 42b of the retainer 42. As shown in FIG. 5, a first end 42a of the retainer 42 is provided with a T-shape that can be inserted into the slot 34 of the accessory attachment track 12. The rotatable handle 44 is rotated in a first direction to clamp the retainer 42 and the main body 40 to the accessory attachment track 12, as indicated in FIG. 5 (the track attached orientation). The rotatable handle 44 is rotated in a second direction in order to release the retainer 42 and the main body 40 from clamping to the accessory attachment track 12, thereby releasing the lighted accessory 14 from the accessory attachment track 12, as indicated in FIG. 6 (the track released orientation). As also shown in FIG. 6, the lighted accessory 14 (and the retainer 42) is rotated 90 degrees such that a narrow dimension of the first end 42a of the retainer 42 allows the retainer 42 to be pulled out of the slot 34 and thereby remove the lighted accessory 14 from the accessory attachment track 12.

The lighting components 46 of the lighted accessory include a battery 70, a switch 72, LED lamps 74 and a wiring harness 76. The battery 70 is removably installed within the battery receiving recess 56. Specifically, a removable cover can be secured to the main body 40 covering the battery receiving recess 56, thereby providing access to the battery 70. The switch 72 is installed within the switch recess 58 and the LED lamps 74 are installed within the lamp receiving apertures 60. The battery 70, the switch 72 and the LED lamps 74 are all electrically connected to one another by the wiring harness 76. The wiring harness 76 is installed within small passageways within the main body 40.

The LED lamps 74 can be LEDs (light emitting diodes) or other types of lighting components. For example, the LED lamps 74 can be replaced with alternative types of illuminating devices, such as incandescent bulbs.

The switch 72 is exposed along an outer surface of the main body 40 of the lighted accessory 14, such that an operator can switch the LED lamps 74 on and off. In the first embodiment, the battery 70 constitutes a power source electrically coupled to the LED lamps 74 via the wiring harness 76.

The lighted accessory 14 is configured such that it can be operated as an illuminating device, regardless of whether or not it is installed to the accessory attachment track 12. The lighted accessory 14 can therefore be used as a hand-held light or as an accessory within the cargo bed 24 of the vehicle 10.

### Second Embodiment

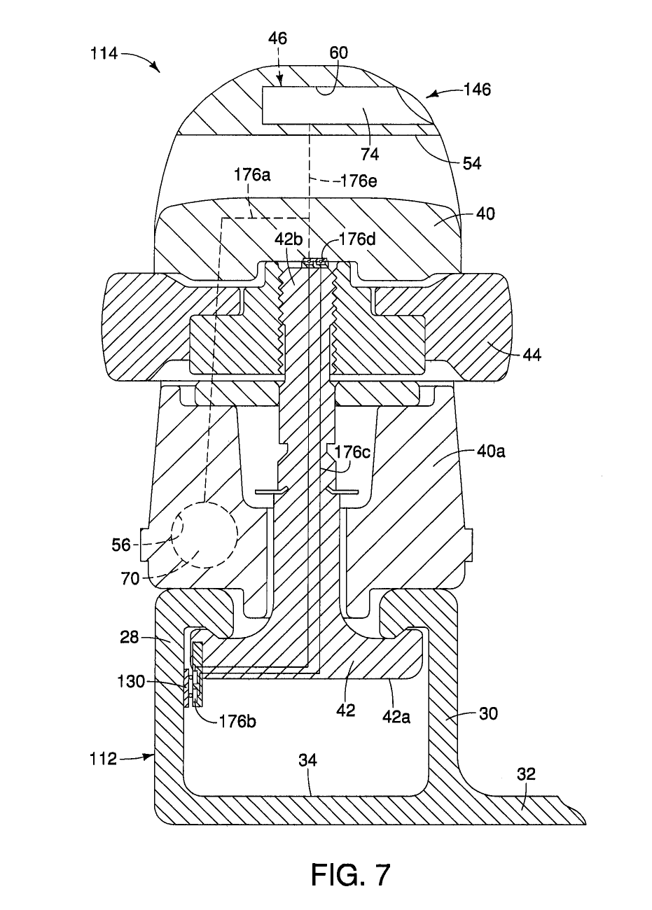

Referring now to FIG. 7, an accessory attachment track 112 and a lighted accessory 114 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The accessory attachment track 112 is identical structurally to the accessory attachment track 12 of the first embodiment and includes the upper portion 28, the lower portion 30, the flange 32 and the slot 34. However, unlike the accessory attachment track 12 of the first embodiment, the accessory attachment track 112 of the second embodiment includes an electric rail 130 mounted within the slot 34 to an inner surface of the upper portion 28 (as shown) or to an inner surface of the lower portion 30. The electric rail 130 can be located at a single predetermined section within the slot 34 of the accessory attachment track 112, thereby defining a charging station. The lighted accessory 114 is moved to the charging station such that the battery 70 is recharged while positioned within the confines of the charging station. Alternatively, the electric rail 130 can extend along the entire length of the slot 34 of the accessory attachment track 112, thereby providing power to the lighted accessory 114 regardless of the positioning of the lighted accessory 114 relative to the length of the accessory attachment track 112.

The lighted accessory 114 includes the main body 40 and the rotatable handle 44 as described above with respect to the first embodiment. However, the retainer 42 of the first embodiment is replaced with a retainer 142 that is described further below. Further, the lighting components 46 of the first embodiment are replace with lighting components 146. The lighting components 146 include some of the components of the first embodiment, such as the battery 70 (which can be a rechargeable battery), the switch 72 (not shown) and the LED lamps 74. However in the second embodiment, the wiring harness 76 of the first embodiment is replaced with a wiring harness 176 that includes a first section 176a, contacts 176b, a second section 176c, commutator 176d and a third section 176e.

The first section 176a electrically connects the battery 70 to the switch 72 (not shown) and the LED lamps 74. The contacts 176b are disposed on the retainer 142 and are positioned to contact the electric rail 130 with the lighted accessory 114 installed to the accessory attachment track 112 and positioned to contact the electric rail 130. The second section 176c electrically connects the contacts 176b to the commutator 176d. The commutator 176d is configured to allow movement of the retainer 142, but maintain an electrical connection between the second section 176c and the third section 176e. The third section 176e is electrically connected to the first section 176a, providing electricity to recharge the battery 70 and/or power the LED lamps 74.

It should be understood from the drawings and the description herein that the electric rail 130 can include both a positive and negative electric contacts, or can alternatively provide a single positive electric contact, with the accessory attachment track 112 itself serving the negative electrical contact. Specifically, the accessory attachment track 112 can be grounded to the body of the vehicle 10, thereby serving as the negative electrical contact.

### Third Embodiment

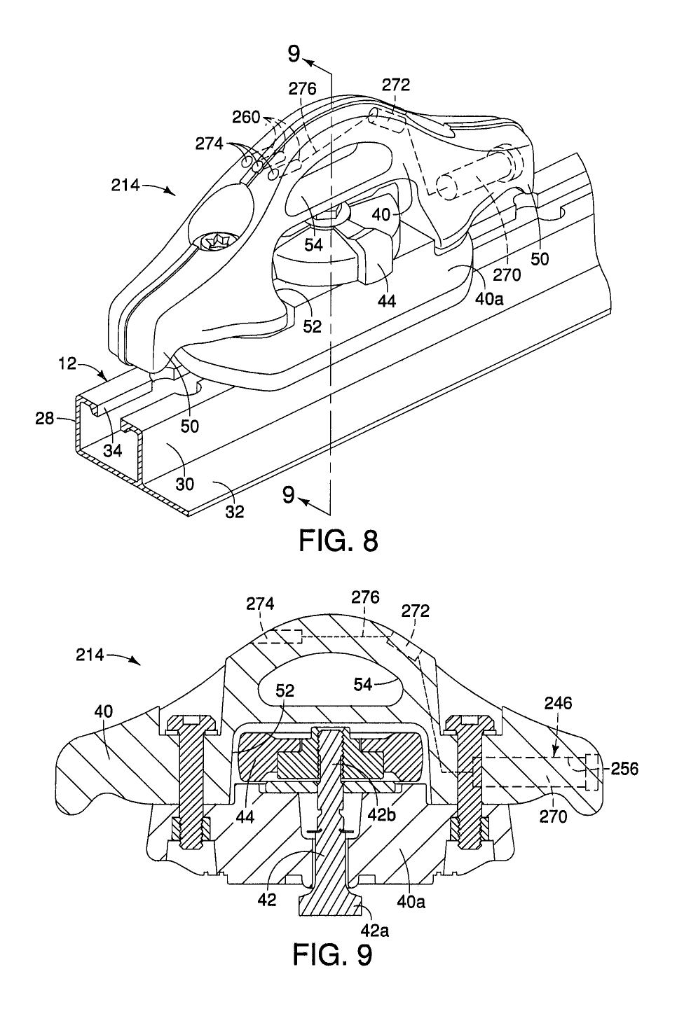

Referring now to FIGS. 8 and 9, a lighted accessory 214 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

In the third embodiment, the accessory attachment track 12 is unchanged, compared to the first embodiment. However, the lighted accessory 214 has been altered in that LED lamps 274 are provided at a different location relative to the main body 40. More specifically, the lighted accessory 214 includes the main body 40, the retainer 42 and the rotatable handle 44 of the first embodiment. However, the lighting components 46 of the first embodiment have been replaced with lighting components 246 in the third embodiment. The lighting components 246 include a battery 270, a switch 272, LED lamps 274 and a wiring harness 276. The battery 270 is the same as the battery 70 of the first embodiment, and the switch 272 is basically the same as the switch 72 of the first embodiment. However, in the second embodiment, the LED lamps 274 are installed at one side of the main body 40, as shown in FIGS. 8 and 9. The wiring harness 276 has been modified to extend to the alternative location of the LED lamps 274.

### Fourth Embodiment

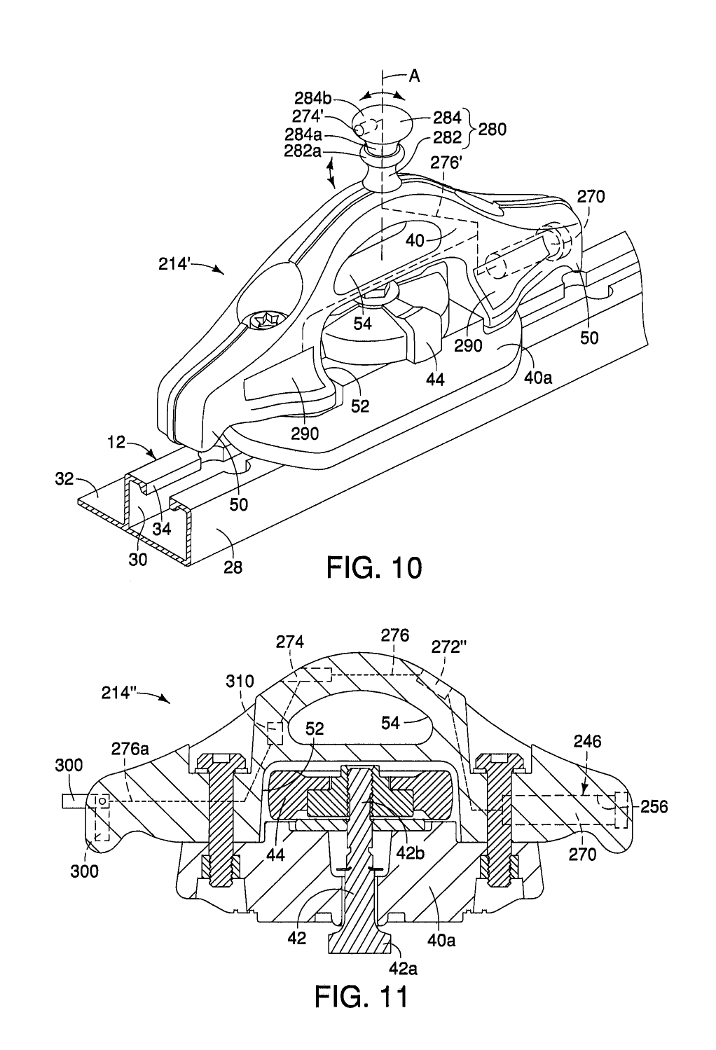

Referring now to FIG. 10, a lighted accessory 214′ in accordance with a fourth embodiment will now be explained. In view of the similarity between the third and fourth embodiments, the parts of the fourth embodiment that are identical to the parts of the third embodiment will be given the same reference numerals as the parts of the third embodiment. Moreover, the descriptions of the parts of the fourth embodiment that are identical to the parts of the third embodiment may be omitted for the sake of brevity.

In the fourth embodiment, the accessory attachment track 12 is unchanged, compared to the first and third embodiments. The lighted accessory 214′ is identical to the lighted accessory 214 of the third embodiment, except that the LED lamps 274 have been removed and replaced with a swiveling joint assembly 280, and additionally, two solar panels 290 are installed to the main body 40 and are electrically connected to the battery 270. The solar panels 290 generate electricity in response to sunlight, thereby recharging the battery 270.

The swiveling joint assembly 280 is pivotally mounted to the main body 40 such that the entire swiveling joint assembly 280 can pivot about an axis of rotation A. More specifically, the swiveling joint assembly 280 includes a base portion 282 and a swiveling portion 284. The base portion 282 is connected to the main body 40 such that it pivots about the axis of rotation A. The base portion 282 includes a socket section 282a. The swiveling portion 284 includes a ball section 284a and a lamp receiving section 284b. The ball section 284a is installed into the socket section 282a such that the swiveling portion 284 can swivel relative to the base portion 282. LED lamps 274′ are installed within the lamp receiving section 284b of the swiveling portion 284. The ball section 284a of the swiveling portion 284 can undergo multiple degrees of pivoting and angular displacement relative to the base portion 282 due to the ball and socket arrangement between the ball section 284a and the socket section 282a. Since ball and socket arrangements are conventional mechanical connections, further description is omitted for the sake of brevity. However, it should be appreciated that the swiveling joint assembly 280 is configured such that the LED lamps 274′ can be aimed in any of a variety of directions.

The wiring harness 276 of the third embodiment is replace in the fourth embodiment with a wiring harness 276′ that electrically connects the solar panels 290 to the battery 270 and the LED lamps 274′ to the battery 270.

It should be understood from the drawings and the description herein that the lighted accessory 14 of the first embodiment can also be modified to include the solar panels 290 in order to recharge the battery 70 of the first embodiment.

### Fifth Embodiment

Referring now to FIGS. 11-13, a lighted accessory 214″ in accordance with a fifth embodiment will now be explained. In view of the similarity between the third and fifth embodiments, the parts of the fifth embodiment that are identical to the parts of the third embodiment will be given the same reference numerals as the parts of the third embodiment. Moreover, the descriptions of the parts of the fifth embodiment that are identical to the parts of the third embodiment may be omitted for the sake of brevity.

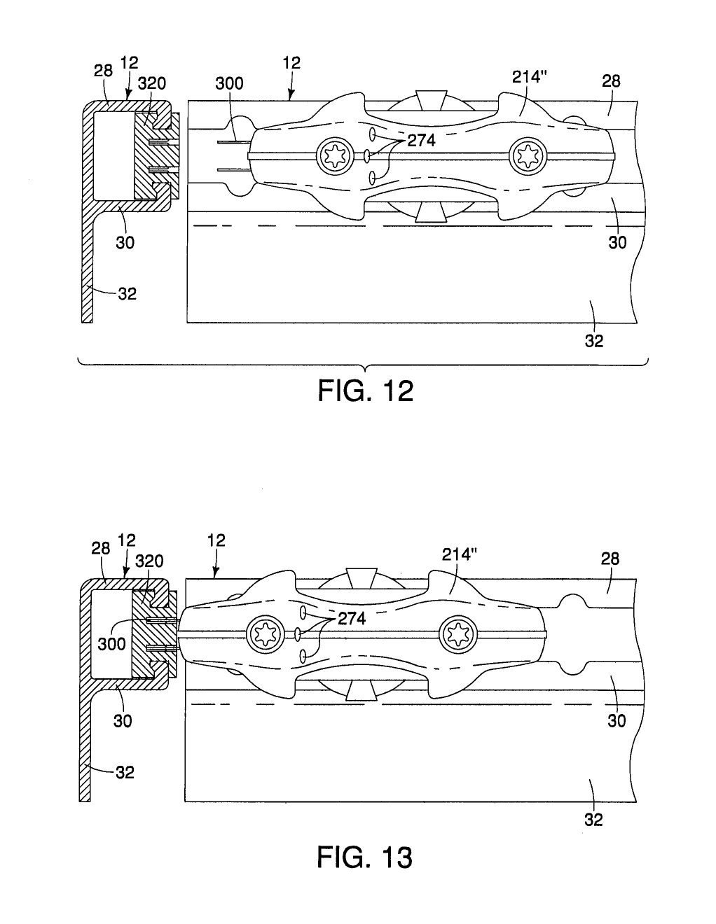

In the fifth embodiment, the accessory attachment track 12 is unchanged, compared to the first and third embodiments. The lighted accessory 214″ is identical to the lighted accessory 214 of the third embodiment, except that a 110 volt plug 300 is pivotally attached to the main body 40 and is electrically connected to the battery 270 via a wiring harness 276″. When the lighted accessory 214″ is removed from the accessory attachment track 12, the 110 volt plug 300 can be plugged into a conventional household outlet or a 110 volt outlet. Alternatively, as shown in FIGS. 12 and 13, a second one of the accessory attachment tracks 12, perpendicular to the first of the accessory attachment tracks 12, can be provided with a 110 volt plug 320. As shown in FIGS. 12 and 13, the lighted accessory 214″ is installed to the first of the accessory attachment tracks 12. However, in FIG. 12, the lighted accessory 214″ is spaced apart from the 110 volt outlet 320 in an “unplugged” state. In FIG. 13, the lighted accessory 214″ is slid along the accessory attachment track 12 until the 110 volt plug 300 fits into the 110 volt outlet 320, in a “plugged-in” state.

Electricity provided to plug 300 is conducted via the wiring harness 272″ in order to recharge the battery 270. The 110 volt plug 300 can alternatively be mounted to the inboard facing surface 22 at the front wall of the cargo area 24 such that it is aligned with the 110 volt plug 300 in the event that the front wall of the cargo area 24 does not include an accessory attachment track 12.

The wiring harness 276 of the third embodiment is replace in the fifth embodiment with the wiring harness 276″ that electrically connects the plug 300 to the battery 270. The battery 270 is further connected to a voltage converter 310 that reduces the 110 volts provided to the plug 300 to the voltage comparable to that of the battery 270.

It should be understood from the drawings and the description herein that the lighted accessory 14 of the first embodiment can also be modified to include the plug 300 and the voltage converter 310 in order to recharge the battery 70 of the first embodiment.

### Sixth Embodiment

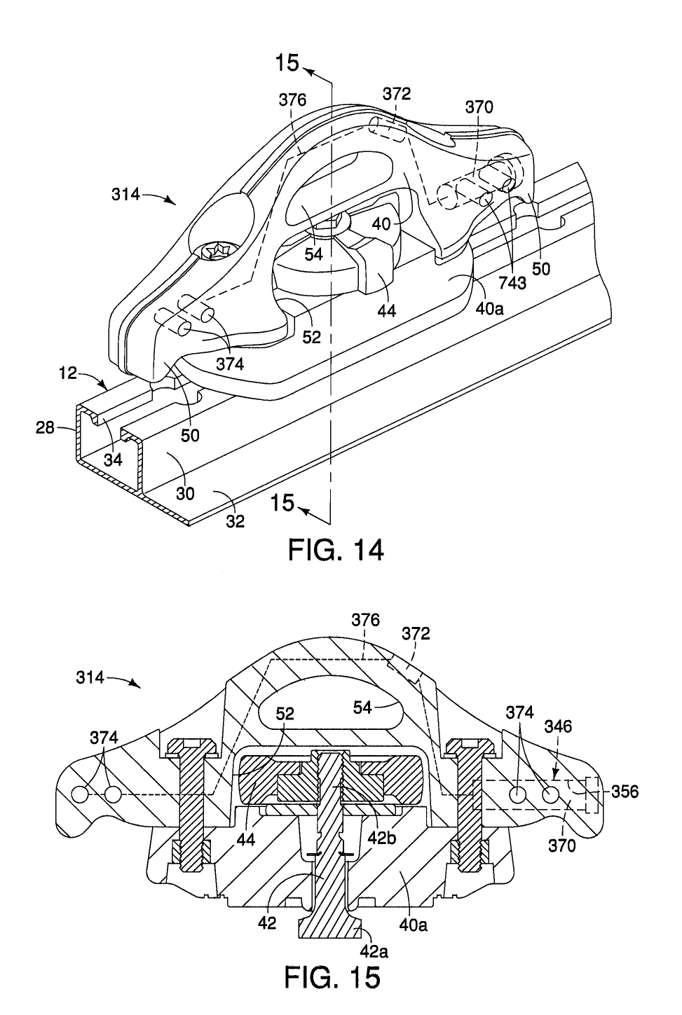

Referring now to FIGS. 14 and 15, a lighted accessory 314 in accordance with a sixth embodiment will now be explained. In view of the similarity between the first and sixth embodiments, the parts of the sixth embodiment that are identical to the parts of the first embodiment will be given the same reference numerals as the parts of the first embodiment. Moreover, the descriptions of the parts of the sixth embodiment that are identical to the parts of the first embodiment may be omitted for the sake of brevity.

In the sixth embodiment, the accessory attachment track 12 is unchanged, compared to the first embodiment. However, the lighted accessory 314 has been altered as compared to the lighted accessory 14 of the first embodiment, in that LED lamps 274 are provided at a different location relative to the main body 40. More specifically, the lighted accessory 314 includes the main body 40, the retainer 42 and the rotatable handle 44 of the first embodiment. However, the lighting components 46 of the first embodiment have been replaced with lighting components 346 in the sixth embodiment. The lighting components 346 include a battery 370, a switch 372, LED lamps 374 and a wiring harness 276. The battery 370 is the same as the battery 70 of the first embodiment, and the switch 272 is basically the same as the switch 72 of the first embodiment. However, in the sixth embodiment, the LED lamps 274 are installed at both ends of the same side of the main body 40, as shown in FIGS. 12 and 13. The wiring harness 376 has been modified to extend to the alternative location of the LED lamps 374.

The various features of the vehicle 10 and the cargo area 24, other than the accessory attachment track 12 and the lighted accessory 14 (and the various embodiments described herein above) are conventional components that are well known in the art. Since various features of the vehicle 10 and the cargo area 24 are well known in the art, these structures will not be discussed or illustrated in detail herein. Rather, it will be apparent to those skilled in the art from this disclosure that the components can be any type of structure and/or programming that can be used to carry out the present invention.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the lighted accessory. Accordingly, these terms, as utilized to describe the present invention should be interpreted relative to a vehicle equipped with the lighted accessory.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle track lighted accessory comprising:
a main body;
a track attachment structure movably connected to the main body between a track attached orientation and a track released orientation;
a lamp at least partially disposed within the main body.

2. The vehicle track lighted accessory according to claim 1, further comprising
a power source electrically coupled to the lamp.

3. The vehicle track lighted accessory according to claim 2, wherein
the power source includes at least one electric contact on a surface of the track attachment structure oriented to contact an electric rail disposed within a slot of an accessory attachment track.

4. The vehicle track lighted accessory according to claim 2, wherein
the power source includes a wiring harness connected to the lamp.

5. The vehicle track lighted accessory according to claim 2, further comprising
a battery disposed within the main body and electrically connected to the lamp.

6. The vehicle track lighted accessory according to claim 5, wherein
the battery is a rechargeable battery.

7. The vehicle track lighted accessory according to claim 6, wherein
the power source further includes at least one electric contact on a surface of the track attachment structure oriented to contact an electric rail disposed within a slot of an accessory attachment track such that with the electric contact being in contact with the electric rail, the battery is recharged.

8. The vehicle track lighted accessory according to claim 6, wherein
the power source further includes a solar panel attached to the main body and electrically connected to the battery.

9. The vehicle track lighted accessory according to claim 6, wherein
the power source further includes an AC plug coupled to the main body and a voltage converter within the main body electrically connected to the AC plug and the battery.

10. The vehicle track lighted accessory according to claim 1, wherein
the main body includes at least one prong.

11. The vehicle track lighted accessory according to claim 1, wherein
the track attachment structure includes a retainer and a rotatable handle operably coupled to the retainer and the main body to clamp the main body and the retainer to an accessory attachment track.

12. A vehicle lighting system comprising:
a cargo area wall structure at least partially defining a vehicle cargo area;
an accessory attachment track coupled to the cargo area wall structure; and
a lighted accessory having:
a main body;
a track attachment structure movably connected to the main body between a track released orientation and a track attached orientation such that in the track attached orientation the track attachment structure attaches to the accessory attachment track; and
a lamp at least partially disposed within the main body.

13. The vehicle lighting system according to claim 12, wherein
the lighted accessory includes a power source electrically coupled to the lamp.

14. The vehicle lighting system according to claim 13, wherein
the power source includes at least one electric contact on a surface of the track attachment structure, and
an electric rail is disposed within a slot of the accessory attachment track such that with the lighted accessory attached to the accessory attachment track, the electric contact contacts the electric rail.

15. The vehicle lighting system according to claim 14, wherein
the electric rail is confined to a segment of the accessory attachment track that is shorter than an overall length of the accessory attachment track.

16. The vehicle lighting system according to claim 14, wherein
the electric rail extends along a majority of the length of the slot of the accessory attachment track.

17. The vehicle lighting system according to claim 13, wherein
the lighted accessory includes a battery disposed within the main body and electrically connected to the lamp.

18. The vehicle track lighted accessory according to claim 17, wherein
the battery is a rechargeable battery.

19. The vehicle lighting system according to claim 18, wherein
the power source further includes a solar panel attached to the main body and electrically connected to the battery.

20. The vehicle lighting system according to claim 18, wherein
the power source further includes an AC plug coupled to the main body and a voltage converter within the main body electrically connected to the AC plug and the battery.
